(19) United States
(12) Patent Application Publication
(10) Pub. No.: US 2014/0223412 A1
(43) Pub. Date: Aug. 7, 2014

(54) Software and method for producing a personalized software application

(71) Applicant: Angelo Stracquatanio, III, Jersey City, NJ (US)

(72) Inventor: Angelo Stracquatanio, III, Jersey City, NJ (US)

(21) Appl. No.: 13/760,501

(22) Filed: Feb. 6, 2013

(51) Int. Cl. G06F 9/44

(52) U.S. Cl. CPC G06F 8/34
USPC 717/107

(57) ABSTRACT

A method of producing a personalized software application comprises providing a software code, prompting a user to provide a personalization input, receiving the personalization input, prompting the user to select at least one software module, receiving a selection of the at least one software module, prompting the user to input a plurality of clients, receiving an input of the plurality of clients, and compiling the software code, including the personalization input and the at least one software module, to produce a personalized software application executable on a mobile device.

### BACKGROUND OF THE INVENTION

The present invention relates to an online, point-and-click, do-it-yourself native mobile application builder that features the ability to permit (or “permission”) content on a user-by-user basis.

Native mobile applications are costly to produce both financially and from a time perspective because one must either hire a custom developer or learn how to write computer code in order to design and build a native mobile app. Additionally, once the application is built, it is difficult to maintain the application without a content management system, and even more challenging is how to manage and permit content on a user-by-user, role or group basis. The other platforms do not allow one to build a native mobile application and permission/target content on a user by user basis.

As can be seen, there is a need for solutions to these and other problems.

### SUMMARY OF THE INVENTION

In one aspect of the present invention, a method of producing a personalized software application comprises: providing a software code; prompting a user to provide a personalization input; receiving the personalization input; prompting the user to select at least one software module; receiving a selection of the at least one software module; prompting the user to input a plurality of clients; receiving an input of the plurality of clients; and compiling the software code, including the personalization input and the at least one software module, to produce a personalized software application executable on a mobile device.

In one aspect, the method further comprises prompting the user to permission each of the plurality of clients so as to permit access to specific content for each of the plurality of clients. In one aspect, the method further comprises prompting the user to input at least one group comprising a plurality of clients. In one aspect, the method further comprises prompting the user to permission the at least one group so as to permit access to specific content for the at least one group.

In one aspect, the method further comprises: receiving data from a plurality of clients corresponding to at least one software module; analyzing the data; and displaying the data to the user.

In one aspect, the personalization input comprises at least one of: a software name, a branding image, a color, and a font. In one aspect, the at least one software module comprises at least one of: a task list, a questionnaire, a survey, a scheduling module, and a digital content feed module.

In one aspect, the method further comprises: providing a mobile device running an operating system; and compiling the software, including the personalization input and the at least one software module, to produce a native application that is native to the operating system.

In one aspect, the method further comprises uploading the application to an application store server accessible by the mobile device. In one aspect, the step of compiling comprises compiling the software code, including the personalization input, the at least one software module, and the input of the plurality of clients, to produce a personalized software application executable on a mobile device.

In one aspect, the method further comprises receiving a selection of a plurality of software modules, wherein the step of compiling comprises compiling the software, including the personalization input and the plurality of software modules, to produce a personalized software application executable on a mobile device.

In one aspect, a system for producing a personalized software application comprises: a machine; and a program product comprising machine-readable program code for causing, when executed, the machine to perform the method as described.

These and other features, aspects and advantages of the present invention will become better understood with reference to the following drawings, description and claims.

### BRIEF DESCRIPTION OF THE DRAWINGS

FIG. 1: is a functional diagram of one embodiment of the invention.

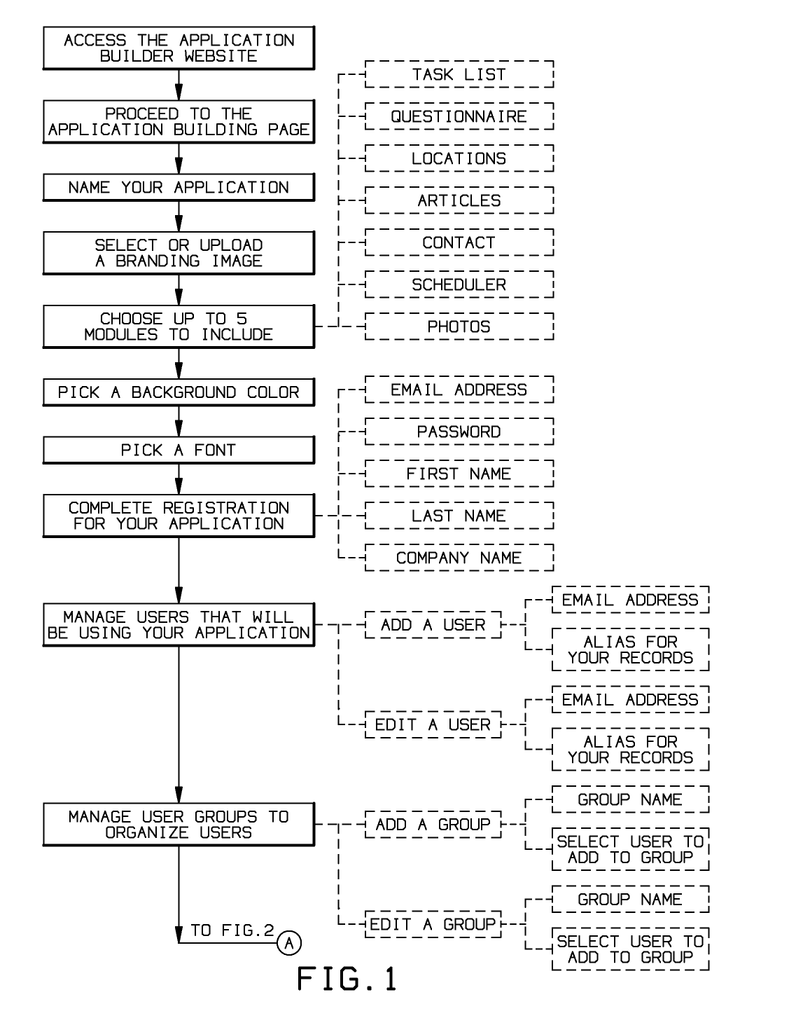

FIG. 2: is a continuation of functional diagram FIG. 1.

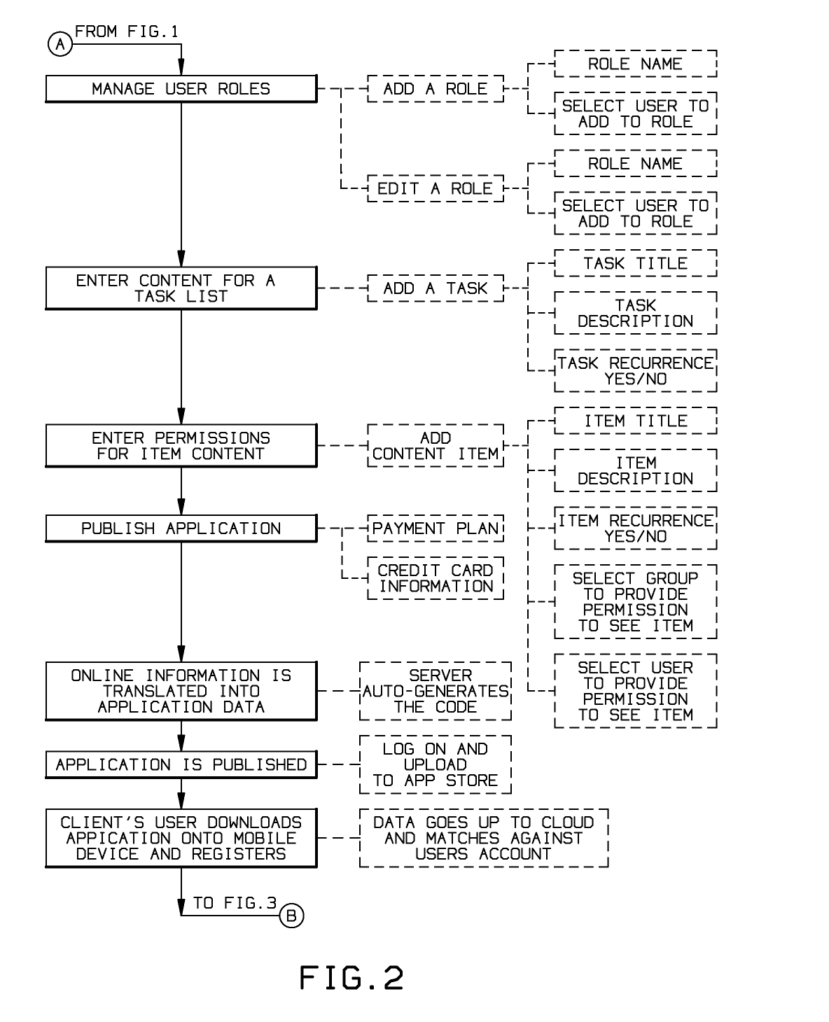

FIG. 3 is a continuation of functional diagram FIG. 2.

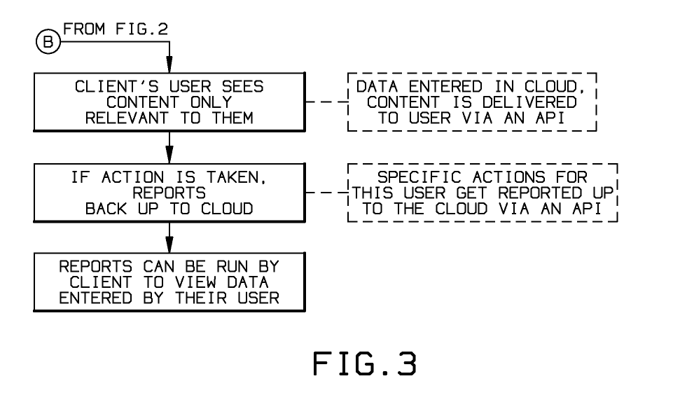

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

The present platform improves on existing systems by allowing a service provider to build a native mobile application (“app”), or an application designed to run on the operating system of the device/processor for which it is designed (such as a mobile device, laptop, tablet, smart phone, iPhone™, Android™ device, etc.) to complement one's service by building an app where they can target and permit content on an individual, group, or role level. However, the ease of use of building a mobile app on the internet is not compromised, and it's just as easy to build an app as on any other platform.

The invention solves the aforementioned problem through the creation of an online, point-and-click, do-it-yourself native mobile application builder that comes pre-packaged with a content management system and user-by-user, role, and group permissioning of content. Another term for permissioning content by user, role or group is Access Control Lists.

This invention is an improvement on what currently exists. Other do-it-yourself mobile application builders exist, but none other offer user-by-user, role or group targeting for content. Additionally, with the present system one can manage all of the users of the app that was built on the present platform on an individual basis.

These other platforms don't work well because for businesses that are service providers, their service is very personalized on a client-by-client basis. Therefore, by building a native mobile app on the existing platforms, they are limited to providing the same content to all of their clients instead of having the ability to target individual or groups of clients to in turn complement their service and improve their core business.

The present invention could be applied to: a mobile website, a tablet application, a desktop application, a website, and other applications.

Referring now to the drawings, an embodiment of the present invention includes several steps:
1. Visit the website according to the present invention, hosting software that executes the present invention.
2. Go to the Get Started page to enter basic app information (“personalization information”), such as name, logos, images, colors, fonts, etc. The user also enters chooses preferred software modules, which could include a task list, which in the final application will display a list of tasks, and when the end-user marks a task as complete, it is logged and recorded, a questionnaire, which in the final application is a personalized survey that can be utilized daily, a survey, a scheduling module, where users can schedule appointments with the app maker, a digital content feed module, which pulls down content from an RSS or Atom feed, as well as links to specific websites, PDFs and other documents as well as links to videos, an images module, which displays images from a Flickr™ gallery, and a contact section, that allows the user to one click call, text, email or view a website, or social media website.
3. Register for the present service.
4. Manage the app clients, such as by adding them, editing them, including name and contact information, etc.
5. Upload/enter content for the app, such as information, images, tasks, questions, appointments, contact information, articles and other content for which permission may be individually granted or withheld to clients, groups, etc.
6. Permission/target that content by user, group or role.
7. Publish the app, such as by first compiling the software application into a personalized software application and then uploading the app to a store server where it can be downloaded by clients. The information entered online may be translated and compiled into a native mobile app, and the app may be published in the respective app stores or online.
8. The clients of the user download the app and register in the app.
9. The clients of the user then see the content developed specially for them which is delivered via an application programming interface (API)/web service that sends back data to the application in a JSON or XML format.
10. If an action is taken by a client, such as a response to a software module (such as a questionnaire), it is recorded and reported (possibly after being analyzed by software, such as graphing software) to the user, such as via a website or even an app used by the user.
11. The user can then manage all of his/her content via the present content management system and run reports on the collected data from their app users.

### How the Invention Works

The website first collects several key data points from the client, such as: the features they want in their app, how they want their app to look, the content that they want in their app and who they want to see that content. Those data points are all stored in the present database and are connected to the client via their user ID and application ID. The application ID is the unique identifier for the mobile application that the user is building. Those data points are all collected on the present website which is a graphical representation of the application and their content.

Once the user subscribes to the present service after they enter all of the aforementioned data, a process is run to take the features that the client chose, also how they want their app to appear, and from there several unique files are generated in the language specific (such as iOS™ Software Development Kit) to the mobile application. Once those files are generated, an additional function is run to auto-include those files in a master mobile application template and once included are compiled into the final personalized software application that may be native to the operating system of the mobile device, allowing the software to run locally and without the need for Internet connection or web-based code or processing. The mobile application template is one master software application that includes all of the individual modules that are offered on the present website.

For example, a blog reader is its own stand-alone module. All of the code that runs that module is self-contained and is only included in the final application if the client chose it. Additionally, the appearance of the app, which is classified as color, font, layout and photos, is all dynamically generated based on what the client chose. Once the final product is auto-compiled an application file is generated and uploaded to the respective app store based on what type of application the client chose. It can also be distributed via the present website.

Once a client of the user downloads and installs the application that was auto-generated following the steps above, he/she enters his/her email address and password to authenticate them for the mobile app. That email address is then linked to the user and a unique ID for that user is sent back to the application and is stored. That unique ID is then used in conjunction with the application ID to communicate with the present web services that return the content that has been permissioned for that user. When that user completes an action in the app, that user ID, the application ID, and the result are POSTed (HTTP protocol for sending information to the server) to the present web service and recorded in the present databases. When the user wants to view the data collected in their application, a query is run and the data is analyzed and/or outputted in a format which is easy to digest for the user.

When a client of the user downloads the app that the user built on the present platform, the content is then delivered to them based on their user ID and application ID. Therefore, any content that the client has permissioned for that client is then delivered to that client via the present web services which implement that core logic. Additionally, if a client performs an action in the app, it is reported back to the web service and recorded based on the user ID and application ID. Therefore, when the user views the data that was collected in his/her app, it is linked to his/her clients only and not one of the other users.

### How to Make the Invention

One might make the invention with the use of several programming languages. The web portion of the invention can be built with a standard web technology/programming language, such as Hypertext Proprocessor (“PHP”). The database that stores the data can be a relational database or a no-sql (non-structured query language) database. The web service/API are also built with the prior web technologies, but one could use a different language if they see fit. The master mobile application may be written in the native language for the device platform. That master application includes every module that is offered on the website, but it is built where all of those modules are self contained objects and are only included in the final product if the user chooses that feature on our website.

The several unique files that may be included in the final mobile application are auto created using the same web aforementioned technologies. Those unique files are app settings files that contain all of the business logic necessary to create a unique application. The appearance for the app is all driven via those app settings files as well as some of the content. The mechanism to auto-compile the mobile application uses third-party tools that auto generate the final application.

There are four important elements: the website, the database, the web services, and the master mobile application. The auto-building of the application is an optional step and is only used to streamline the present operations.

### How to Use the Invention

A person would use this invention to solve the problem of it being too costly to develop a custom mobile application and too difficult to manage content in the application on a user by user basis, by first visiting the present website. Once on the present website they choose how their app will look, what features will be included in their app, what content they want in their app, and who they want to view that content. This is all done online via the present graphical user interface using a web browser, a mouse and a keyboard. One has to type in or upload his/her content, but for the appearance and features one just has to choose from a list of options. To permission content on a user-by-user basis, one must add a user to the system first, or let a user sign up in one's app, and then select that user when adding content on the present website. The user of our client's app will download the app onto one's device, register using one's email and password, and from there consume and act on the content that the client created.

This invention can be used wherever computer applications are created and content needs to be targeted on a specific basis when a user does not have programming experience.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention.

What is claimed is:

1. A method of producing a personalized software application, comprising:
providing a software code;
prompting a user to provide a personalization input;
receiving the personalization input;
prompting the user to select at least one software module;
receiving a selection of the at least one software module;
prompting the user to input a plurality of clients;
receiving an input of the plurality of clients; and
compiling the software code, including the personalization input and the at least one software module, to produce a personalized software application executable on a mobile device.

2. The method as claimed in claim 1, further comprising prompting the user to permission each of the plurality of clients so as to permit access to specific content for each of the plurality of clients.

3. The method as claimed in claim 1, further comprising prompting the user to input at least one group comprising a plurality of clients.

4. The method as claimed in claim 3, further comprising prompting the user to permission the at least one group so as to permit access to specific content for the at least one group.

5. The method as claimed in claim 1, further comprising:
receiving data from a plurality of clients corresponding to at least one software module;
analyzing the data; and
displaying the data to the user.

6. The method as claimed in claim 1, wherein the personalization input comprises at least one of: a software name, a branding image, a color, and a font.

7. The method as claimed in claim 1, wherein the at least one software module comprises at least one of: a task list, a questionnaire, a survey, a scheduling module, and a digital content feed module.

8. The method as claimed in claim 1, further comprising:
providing a mobile device running an operating system; and
compiling the software, including the personalization input and the at least one software module, to produce a native application that is native to the operating system.

9. The method as claimed in claim 1, further comprising uploading the application to an application store server accessible by the mobile device.

10. The method as claimed in claim 1, wherein the step of compiling comprises compiling the software code, including the personalization input, the at least one software module, and the input of the plurality of clients, to produce a personalized software application executable on a mobile device.

11. The method as claimed in claim 1, further comprising receiving a selection of a plurality of software modules, wherein the step of compiling comprises compiling the software, including the personalization input and the plurality of software modules, to produce a personalized software application executable on a mobile device.

12. A system for producing a personalized software application, comprising:
a machine; and
a program product comprising machine-readable program code for causing, when executed, the machine to perform the method as claimed in claim 1.
